(19) United States
(12) Patent Application Publication
(10) Pub. No.: US 2004/0107450 A1
(43) Pub. Date: Jun. 3, 2004

(54) Contents conversion control method and contents use system

(76) Inventor: Mei Kodama, Hiroshima (JP)

Correspondence Address: WELLS ST. JOHN P.S., 601 W. FIRST AVENUE, SUITE 1300, SPOKANE, WA, 99201, US

(21) Appl. No.: 10/719,231

(22) Filed: Nov. 19, 2003

(30) Foreign Application Priority Data
Nov. 28, 2002 (JP) 2002-344769

(51) Int. Cl. H04N 7/16; H04N 11/00; H04N 7/00

(52) U.S. Cl. 725/135; 725/136; 348/460; 348/461

(57) ABSTRACT

Converting operation information for converting and controlling contents and contents information extracted by the contents distinction section 3 from contents are inputted to the information conversion management section 4. Besides, contents are outputted to the information conversion section 5. The information conversion management section 4 controls the information conversion section 5 in accordance with the converting operation information and the contents information, and the information conversion section 5 converts the inputted contents under control of the information conversion management section 4. Following to the above conversion, the user terminal receives the converted contents provided with a desired quality of contents.

### RELATED APPLICATION

This application relates to and claims a priority from corresponding Japanese Patent Application No. 2002-344769 filed on Nov. 28, 2002.

### BACKGROUND OF THE INVENTION

1. Field of the Invention

The present invention relates to a method for converting and controlling contents that include multi-media information such as images, audios, texts and map information, and more particularly to an information conversion method for using, storing and editing contents in accordance with a use environment of the contents and to a contents use system for using the information conversion method.

2. Description of the Related Art

Usually, a user terminal, for example, a personal computer and a television receiver, is configured to receive contents that are previously created in accordance with a preformed user terminal. If a user terminal does not meet contents, the contents are converted by means of a device that performs only a predetermined and dedicated information conversion processing, as described in, for example, the Japanese patent application Kokai publication No. Hei 8-297565. That is, it is required to design or prepare a special information converter restricted to a use environment and object of use of the user terminal. Moreover, if the user terminal is a computer, the contents have been used without conversion by the user terminal even though the contents quality is out of the processing capability of the user terminal.

Also, it has been difficult to specify the relation between a user and contents in order to designate a receiving channel for the contents at the user side. Therefore, when the same user uses the same contents, information has been delivered respectively for each mode of networks and each terminal to be used.

According to the prior art information conversion methods, however, it has been required for a contents provider to prepare the contents into a plurality of file formats and file qualities based on the user terminals of contents users who are assumed as the users beforehand. Hence, enormous costs and time have been required to spend for this operation. Furthermore, it has been considered difficult to add and/or change a conversion processing with respect to the information conversion processing having been once set, when a special information converter dedicated for a certain use environment and purpose is prepared. Hence, when the contents are required to be converted for the other contents user, for example, they have been required to redesign the information converter from the beginning. Still further, in the methods of the prior art, it was difficult to realize a conversion system that controls a plurality of information converters in order to convert the contents since the information conversion section does not manage input/output data formats. Further, even though the contents quality exceeds the processing capability of a user terminal, it has been required to once download the contents as it is or the like into the user terminal. Hence, unnecessary communication costs and time have been spent for such operations. Again, even when the same user uses the same contents, if a mode of access and/or a type of the terminal is different, it has been required to download the contents or the like again. Hence, it was not possible to realize efficient use of a storage medium and/or a network resource that are limited in their capacities. In addition, there has been such a trouble for the users that they are obliged to doubly pay contents use charges for the same contents.

### SUMMARY OF THE INVENTION

Taking the circumstance as described above into consideration, it is an object of the present invention to provide an information conversion control method that converts contents into one adaptable to a terminal used by the user based on contents information which is attribute information related to contents and converting operation information for converting and controlling the contents, and a contents use system that uses the information conversion control method to use contents.

The information conversion method of the present invention that achieves the object of the present invention comprises:

a step for inputting converting operation information that converts and controls contents into an information conversion management section,

a step in which a contents distinction section distinguishes that the contents are inputted, extracts contents information, which is included in the contents and is an attribute information related to the contents, inputs the contents information to the information conversion management section, and outputs the contents to an information conversion section,

a step in which the information conversion management section controls the information conversion section based on both the converting operation information and the contents information,

a step in which the information conversion section converts the inputted contents by the control of the information conversion management section, and

a step in which the user terminal receives the converted contents.

The information conversion method of the present invention may be configured in another constitution such that the information conversion management section includes a registration processing section, a relevant information storage section, a retrieval processing section and a command processing section. The registration processing section registers conversion information having information conversion section performance information and conversion processing procedure information, such as types of convertible contents of the information conversion section. The relevant information storage section stores the conversion information registered by the registration processing section. The retrieval processing section retrieves the conversion information by means of the relevant information storage section with the converting operation information and the contents information being used as an input, and outputs results of the retrieval. The command processing section receives the contents information and the conversion information outputted from the retrieval processing section, decides the operation of the information conversion section, calculates a conversion initial parameter that actuates the information conversion section and outputs altered contents obtainable by adding the conversion initial parameter to the contents information. The user terminal receives the altered contents information.

Besides, the information conversion section may be configured to include one or more contents conversion sections, a switch section and a data verification section. The contents conversion section is operated by receiving the calculated conversion initial parameter from the command processing section to operate. The switch section that selects the one or more contents conversion sections is controlled by the command processing section based on the conversion information. The data verification section verifies the converted contents that are produced by conversion by the contents conversion section.

Again, the user terminal may be configured such that it is connected to the information conversion management section and the information conversion section via an electric communication network and receives the converted contents outputted from the information conversion section and the altered contents information outputted from the information conversion management section via the electric communication network.

Besides, the information conversion section may be connected to the contents distinction section and the information conversion management section via the electric communication network.

Again, the user terminal may be configured to select the contents to be used, prepare the converting operation information to be inputted to the information conversion management section-and send it to the information conversion management section.

In this concern, the information conversion section may be one that converts the inputted contents depending on the quality of the contents required by the user terminal.

Besides, the contents use system using the above-described information conversion control method is consisted of a user terminal and an information management section, both configured as described below. That is, the user terminal is configured such that it is provided with:

an information input/output section in which the user terminal receives personal information related to the user and selects the contents presented by the information management section,

a contents registration processing section for a user terminal for registering the contents used by the user,

a contents storage section for a user terminal for storing the contents registered by the contents registration processing section for a user terminal,

a contents read-out processing section for a user terminal for reading out the contents from the contents storage section for a user terminal,

a contents information registration processing section for a user terminal for registering the contents information including information related to contents, such as titles, IDs and information formats of contents and as to accesses to contents,

a contents information storage section for a user terminal for storing the contents information registered by the contents registration processing section for a user terminal,

a contents information retrieval processing section for a user terminal for using IDs included in the contents information as an input, retrieving the contents information corresponding to the inputted IDs by means of the contents information storage section for a user terminal, and outputting the retrieved contents information, and

a transmission/reception section for a user terminal for performing transmission/reception of data with the information management section via the electric communication network. Whereas, the information management section is configured by being provided with:

a user registration processing section for registering personal information of users, such as names, addresses, ages, passwords and IDs, and user information related to accesses of users,

a use information storage section for storing the personal information of users and the user information registered by the user registration processing section,

a user information retrieval processing section for using the personal information as an input, retrieving user information corresponding to the input information by means of the user information storage section, and outputting the retrieved user information,

a contents information registration processing section for the information management section for registering the contents information in which information related to contents, such as titles, IDs and information formats of contents, and related to accesses to the contents are included,

a contents information storage section for the information management section for storing the contents information registered by the contents information registration processing section for the information management section,

a contents information retrieval processing section for the information management section for using IDs included in the contents information as an input, retrieving contents information corresponding to the inputted IDs by means of the contents information storage section for the information management section, and outputting the retrieved contents information,

a contents use information registration processing section for registering contents use information related to use histories of contents corresponding to the users,

a contents use information storage section for storing the contents use information registered by the contents use information registration processing section,

a contents use information retrieval processing section for using the user information outputted by the user information retrieval processing section and the contents IDs outputted by the contents information retrieval processing section as an input, retrieving contents use information corresponding to the inputted information by means of the contents use information storage section, and outputting the retrieved contents use information,

a user authentication section for authenticating IDs, passwords and so on of the users to thereby determine whether the users can use the contents or not,

a contents registration processing section for the information management section for registering contents,

a contents storage section for the information management section for storing the contents registered by the contents registration processing section for the information management section,

a contents read-out processing section for the information management section for reading out the contents from the contents storage section for the information management section, and

a transmission/reception section for the information management section for performing transmission/reception of data with the user terminal via the electric communication network.

Further, an accounting processing section, which charges for their use of the contents, may be included in the information management section.

The information management section may further include a contents remote control section for making up control information that remotely controls the information conversion section provided for the information conversion control method for the user terminal.

Furthermore, the information management section may include a contents charge calculation section for calculating use charges for use of the contents and a contents use charge collection section for collecting the use charges calculated by the contents charge calculation section, and the user terminal may further include a contents charge payment section for paying the charges for the use of the contents.

Again, the information management section may be configured to include a contents conversion charge calculation section for calculating conversion charges required for converting the contents and a contents conversion charge collection section for collecting the calculated conversion charges by the contents conversion charge calculation section, and the user terminal may be configured to further include a contents conversion charge payment section for paying the conversion charges required for converting the contents.

### BRIEF DESCRIPTION OF THE DRAWINGS

The above and other objects, features and advantages of the present invention will be apparent from the following description of preferred embodiments of the invention explained with reference to the accompanying drawings, in which:

FIG. 1 is a block diagram for explaining the information conversion control method according to the present invention;

FIG. 2 is a block diagram of an information conversion management section and an information conversion section provided for: the information conversion control method according to the present invention;

FIG. 3 is a flow chart for explaining a flow of the information conversion control method according to the present invention;

FIG. 4 is a block diagram for explaining the contents use system according to the present invention;

FIG. 5 is a flow chart for explaining a flow of the contents use system according to the present invention; and

FIG. 6 is a flow chart for explaining a flow of an accounting processing on the contents use system according to the present invention.

### PREFERRED EMBODIMENTS OF THE INVENTION

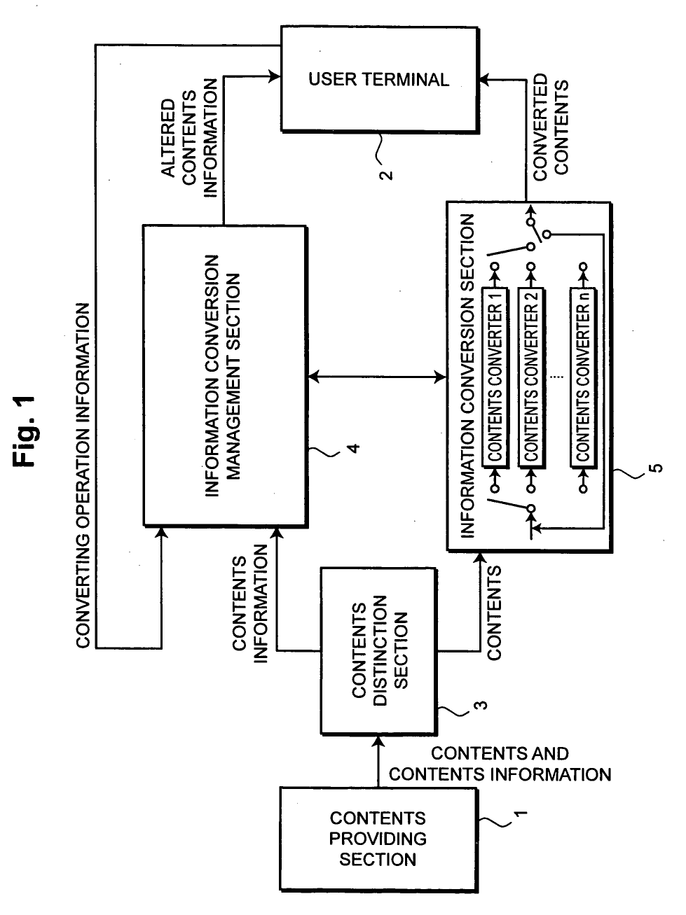

Now, several embodiments for the present invention are explained with referring to the examples shown in the appended drawings. FIG. 1 is a block diagram representing the relation between various functional elements for explaining the information conversion control method according to the present invention. Note that the term of contents denotes so-called multi-media information in general, such as movie images, still images, audios, texts and map information, and the term of contents information denotes attribute information related to contents, such as names of writers, dates of writings, formats of information and altered information.

In a contents providing section 1, which is a server or the like of a contents provider, a plurality of contents are stored beforehand for providing them to users. When a contents use request is issued from a user terminal 2 used by a user who desires to use the contents, the contents providing section transmits the contents in the original state to a contents distinction section 3. Note that, in the original contents, attribute information, for example, contents information related to contents themselves, such as names of writers, dates of writings, formats of information and altered information, are contained. The contents distinction section 3 distinguishes that contents have been inputted, extracts contents information contained in the contents, inputs the contents information to an information conversion management section 4, and further inputs the contents to an information conversion section 5. Besides, converting operation information for converting and controlling the contents from the user terminal 2 is transmitted to the information conversion management section 4. The information conversion management section 4 controls and manages the information conversion section 5 based on the inputted converting operation information. Besides, the information conversion section 5 includes a plurality of contents converters and works as a conversion section for obtaining a desired converted contents by converting the contents controlled and inputted by the information conversion management section 4 by means of a predetermined contents converter. As shown in the figure, the information conversion section 5 includes a plurality of contents converters. The information conversion section allows to keep up with user's requests with every types of formats and qualities of the contents through such procedures that a plurality of contents converters are used by switching and are used plural times in a way that the contents are fed back repeatedly to the input terminals of the information conversion section upon requirements.

The converting operation information transmitted from the user terminal 2 is an information related to the quality of the contents desired by the user terminal 2, which include, for example, data capacities, data formats, numbers of colors of images and so on. Any contents in the contents providing section 1 are selected by the user terminal 2, and the converting operation information, such as conditions, requirements and so on for conversion processing of the contents, is made up. Note that, although the converting operation information is inputted from the user terminal 2 to the information conversion management section 4 in the above description, the present invention is not limited to that embodiment, and the converting operation information may be inputted from the contents provider side. For example, when the contents providing section provides contents plural times at a certain time intervals with different qualities each time and the user terminal receives contents at the time at which contents with a quality that keeps up with the user terminal are provided, inputs of the converting operation information performed from the contents provider side may occasionally be convenient.

It becomes needless for the contents providing section 1 to separately prepare contents having a plurality of contents qualities for each of the user terminals. As a result, it is realized to effectively use a contents storage section such as a storage medium. Further, the user terminal 2 may be configured to receive not only the converted contents from the information conversion section 5 but also information on how the contents are converted from the information conversion management section 4, that is, the altered contents information that is made up by adding a conversion initial parameter having actuated the information conversion section to the contents information, and the like. This altered contents information may be used as well, for example, when the contents are transmitted from the user terminal 2 to the other terminals. Furthermore, since it is possible to check how the contents were converted and the like, the converted contents can be converted back to the original contents depending on their formats.

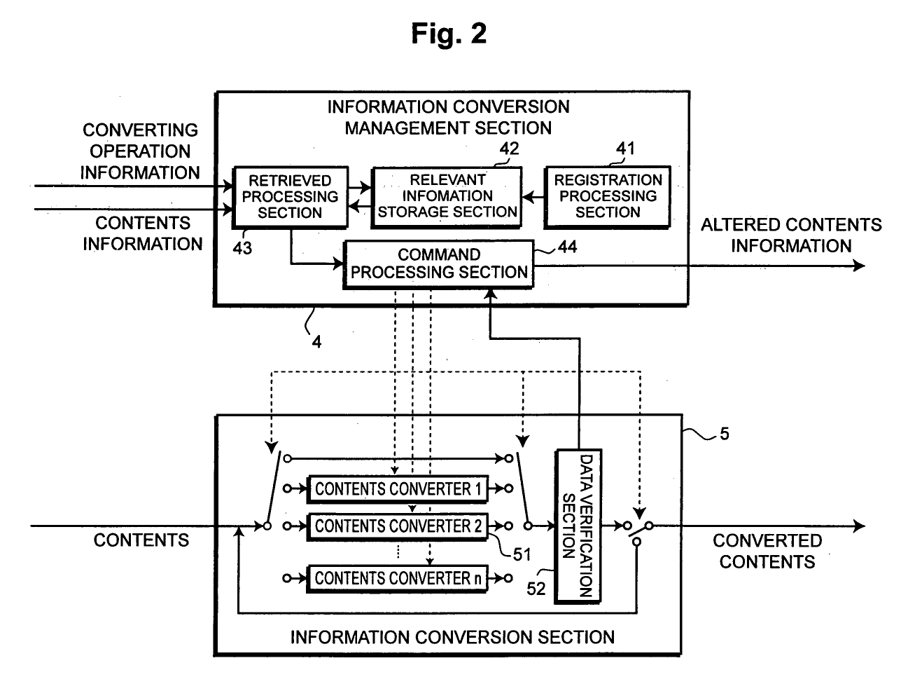

Now, the information conversion management section 4 and the information conversion section 5 are described in detail with reference to FIG. 2. As shown in this figure, the information conversion management section 4 includes a registration processing section 41, a relevant information storage section 42, a retrieval processing section 43 and a command processing section 44. The registration processing section 41 has a function to register conversion information comprising types of contents convertible in the information conversion section 5, types and performances of a plurality of contents converters 51 and information on procedures in the conversion processing. The relevant information storage section 42 is adapted to store the conversion information registered by the registration processing section 41 in a storage medium or the like. The retrieval processing section 43 is adapted to retrieve the conversion information stored in the relevant information storage section 42 in order to search which contents converter 51 should be used for the inputted contents and the like based on the converting operation information and contents information inputted to the information conversion management section 4 and to output the results of the retrieval. The command processing section 44 is adapted to receive the contents information and the output results from the retrieval processing section 43, decides the operation of the information conversion section 5 and calculates the conversion initial parameter that actuates the information conversion section 5. Based on the calculation, a plurality of contents converters 51 provided in the information conversion section 5 are controlled, and desired converted-contents are outputted from the information conversion section 5. Further, the command processing section 44 may be configured to output the altered contents information that is made up by adding the conversion initial parameter to the contents information.

As described above, the information conversion section 5 allows to keep up with every types of formats and qualities of the contents through such procedures that a plurality of contents converters 51 are provided and are used plural times in a way that the contents are fed back repeatedly to the input terminals of the information conversion section upon requirements. The contents conversion section 51 is actuated by the conversion initial parameter calculated by the command processing section 44. This converting function may have either single function or plural functions. Further, a data verification section 52 to be connected to the command processing section 44 may well be provided to check the converted contents converted by the contents converter 51 in order to avoid generation of undesired contents due to incorrect conversions or breaking of contents from occurring.

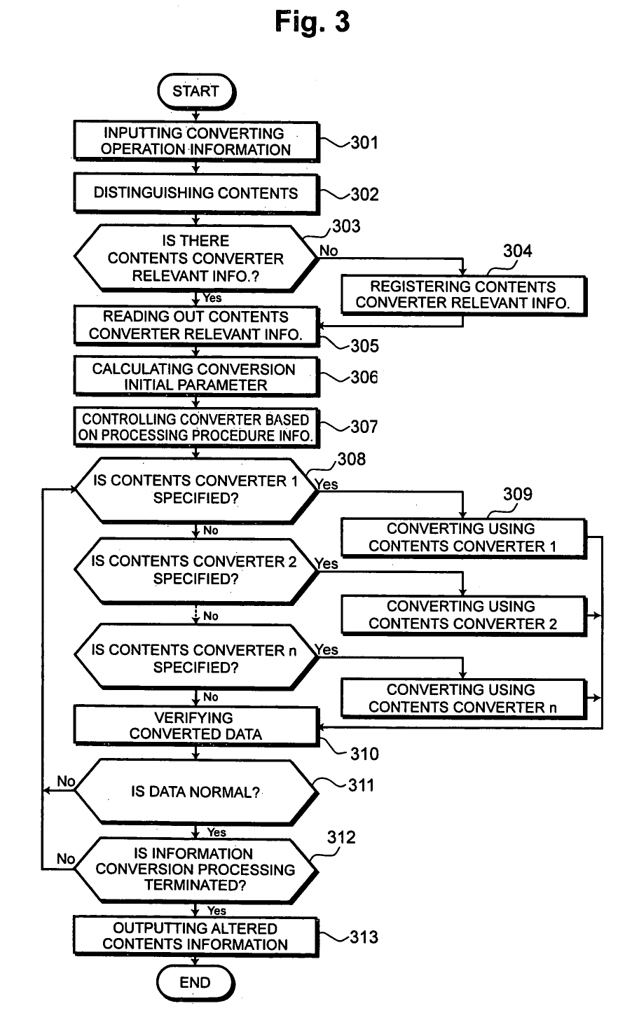

Now, the flow of the information conversion control method according to the present invention is described with reference to FIG. 3. Firstly, the converting operation information is inputted to the retrieval processing section 43 in the information conversion management section 4 (Step 301). Then, the contents information is extracted from the contents inputted in the contents distinction section 3, and the contents information is inputted to the retrieval processing section 43 (Step 302). In the retrieval processing section 43, conversion information comprising information conversion section performance information, such as types of contents able to be converted by the information conversion section 5, and conversion processing procedure information, those which are stored in the relevant information storage section 42, based on the inputted converting operation information and contents information (Step 303). In case there is no corresponding conversion information, the conversion information is registered by means of the registration processing section 41 (Step 304). More specifically, the registration processing section 41 registers performance information related to the information conversion section, such as types of the contents converters 51 to be used and types of convertible input/output contents, and conversion processing procedure information concerning how the information conversion processing is performed and the like, based on the converting operation information and the contents information. In case the corresponding conversion information presents in Step 303, the retrieval processing section 43 reads out the conversion information from the relevant information storage section 42 and then outputs it to the command processing section 44 (Step 305). Then, the command processing section 44 decides the operation of the information conversion section 5 when it performs the conversion processing based on the inputted conversion information and calculates the conversion initial parameter for controlling and actuating the information conversion section (Step 306). Then, the command processing section controls certain contents converters 51 in the information conversion section 5 (Step 307). At this time, the contents converters 51 required for the conversion are specified (Step 308), and the required contents converters are used to convert the contents based on the conversion initial parameter (Step 309). Then, the converted contents are verified in the data verification section 52 (Step 310). In case an abnormal data was detected in the converted contents as a result of the verification in the data verification section 52, the operation is backed to Step 308 in order to perform the conversion operation again (Step 311). If the contents were detected as being normal as a result of the verification, the conversion operation is terminated in accordance with the conversion information, or the contents are checked if they are further required to be converted by the contents converters or not (Step 312). In case the further conversion is required, the operation is backed to Step 308. In case the conversion processing is terminated, the converted contents that finished the conversion processing and the altered contents made up by adding the conversion initial parameter to the contents information in the command processing section 44 are outputted to the user (Step 313).

As described above, the present invention allows to convert contents into the forms that suit to the use environments of the users based on the contents information and the converting operation information and provide the converted contents to the users. The information conversion section includes various types of contents converters so that the method of the present invention can keep up with every conversion requests.

In FIG. 1, the user terminal 2 may be configured to be connected to the information conversion management section 4 and the information conversion section 5 via an electric communication network, e.g. the internet. In this case, the converted contents outputted from the information conversion section 5 and the altered contents information outputted from the information conversion management section 4 are received by the user terminal 2 via the internet. With this arrangement, the user terminal 2 can use required contents even from a remote location. Furthermore, the information conversion section 5 may be configured such that it is connected to the contents distinction section 3 and the information conversion management section 4 via an electric communication network. Specifically, it becomes possible to provide the information conversion section of the present invention to a repeater or the like in an electric communication network.

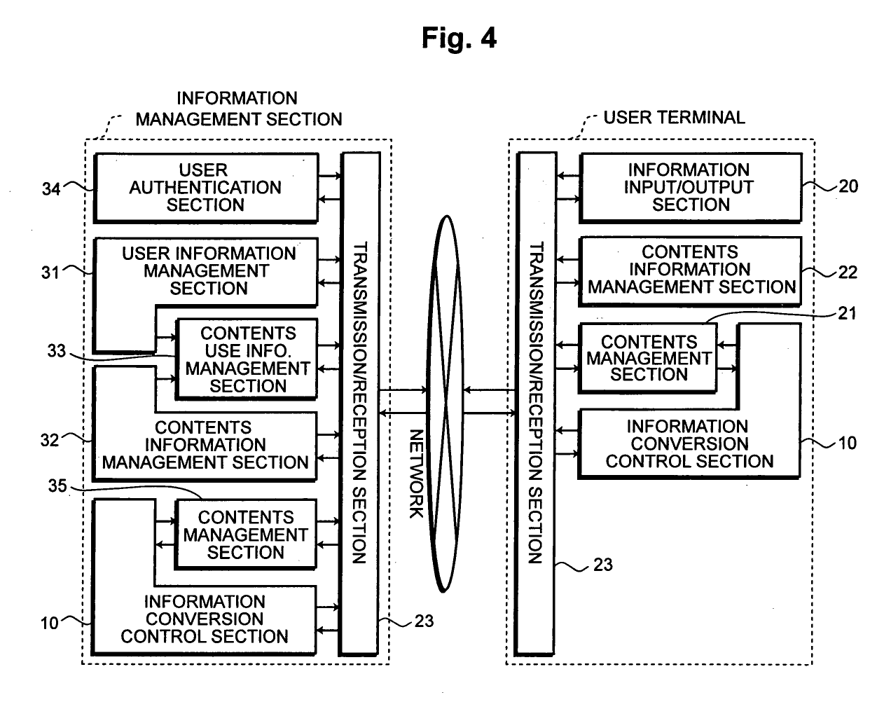

Now, a contents use system that uses the above-described information conversion control method according to the present invention to thereby enable the user terminal to use contents via the electric communication network is described with reference to FIG. 4. FIG. 4 is a block diagram for explaining the contents use system according to the present invention. This system is configured such that a user terminal is connected to the information management section via the electric communication network. In this figure, the information conversion control section denoted with a reference numeral 10 is a block that carries out the aforementioned information conversion control method. In the figure, the information conversion control sections are provided in both the user terminal and the information management section. However, the present invention is not limited to this embodiment, and the information conversion control section may be provided to the information management section side only.

Firstly, the configuration of the user terminal side is described. The information input/output section 20 is adapted to input personal information related to a user, for example, information that specifies an individual user, such as name, address and age. Also, the information input/output section 20 is used to select contents presented by the information management section. The contents management section 21 for the user terminal is adapted to register, store and manage received contents, and it comprises a contents registration processing section for registering contents used by the user, a contents storage section for storing the contents registered by the contents registration processing section, and a contents read-out processing section for reading out the stored contents in the contents storage section. The contents information management section 22 comprises a contents information registration processing section for registering contents information including information related to contents, such as titles, IDs and information formats of contents, and information on accesses to contents, a contents information storage section for storing the contents registered by the contents information registration processing section, and a contents information retrieval processing section for using IDs included in the contents information as an input, retrieving contents information corresponding to the inputted IDs by means of the contents information storage section and outputting the retrieved contents information. The transmission/reception section 23 is adapted to perform transmission/reception of data with the information management section via an electric communication network. Specifically, the transmission/reception section is adapted to receive contents of the information management section and send personal information and converting operation information.

Next, the configuration of the information management section side is described. The user information management section 31 comprises a user information registration processing section for registering personal information, such as names, addresses, passwords and IDs of users, and user information related to accesses of users, a user information storage section for storing the user information registered by the user information registration processing section, and a user information retrieval processing section for using the personal information as an input, retrieving user information corresponding to the inputted personal information by means of the user information storage section and outputting the retrieved user information. The contents information management section 32 comprises a contents information registration processing section for registering contents information including information related to contents, such as titles, IDs and information formats of contents, and related to accesses to contents, a contents-information storage section for storing the contents information registered by the contents information registration processing section, and a contents information retrieval processing section for using IDs included in the contents information as an input, retrieving contents information corresponding to the inputted ID by means of the contents information storage section, and outputting the retrieved contents information. The contents use information management section 33 comprises a contents use information registration processing section for registering contents use information related to use histories of contents corresponding to users, a contents use information storage section for storing the contents use information registered by the contents use information registration processing section, and a contents use information retrieval processing section for using user information outputted by the user information retrieval processing section and contents ID outputted by the contents information retrieval processing section as an input, retrieving contents use information corresponding to the inputted information by means of the contents use information storage section and outputting the retrieved contents use information. Besides, the user authentication section 34 is adapted to use IDs and passwords of users to authenticate the users and determine whether the contents can be used for the users or not. Then, the contents management section 35 for the information management section comprises a contents registration processing section for registering contents, a contents storage section for storing the contents registered by the contents registration processing section, and a contents read-out processing section for reading out the contents stored in the contents storage section.

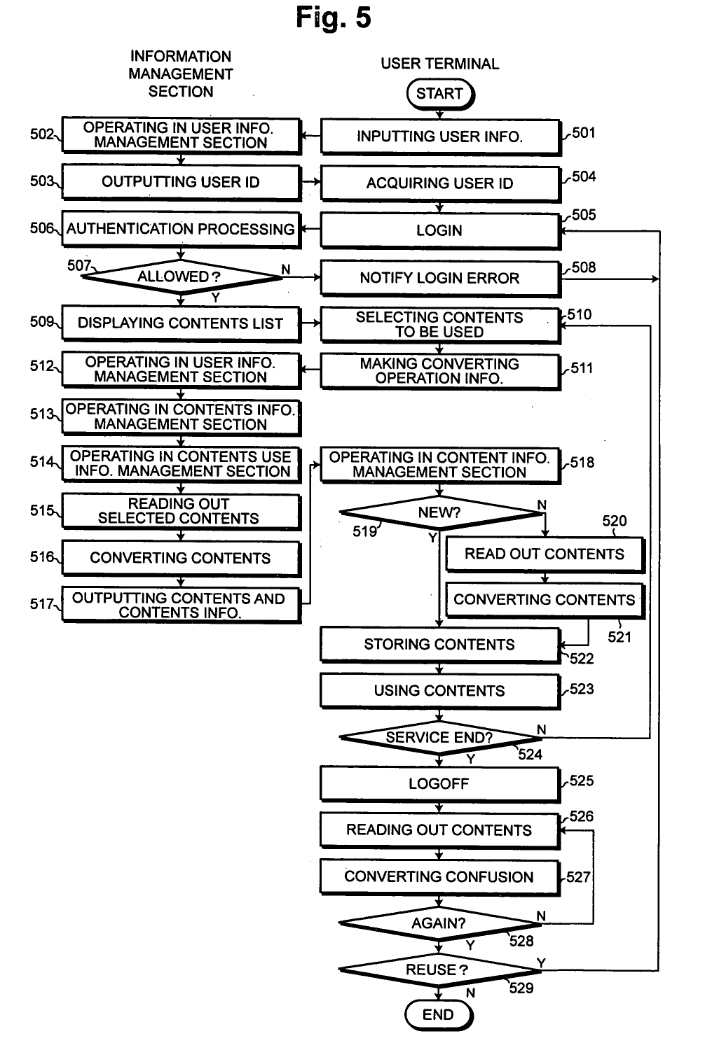

Next, the flow of the contents use system according to the present invention is described below with reference to a flow chart shown in FIG. 5. Firstly, users are registered into the information management section at the user terminal side by means of the information input/output section 20 (Step 501). More specifically, personal information related to individual users, such as names, addresses, ages and the like of users, is inputted on the information input/output section 20. The inputted personal information is transmitted by the transmission/reception section 23 to the information management section via an electric communication network, and the transmitted information is registered and stored in the user information management section 31 as user information (Step 502). When the user information is initially registered in the user information management section 31, the user information management section 31 outputs a user ID, password and so on of a user to the user terminal (Step 503). The information such as a user ID and a password is transmitted to the user terminal via an electric communication network so that the user can acquire a user ID, a password and so on (Step 504). When a user desires to use the contents use system according to the present invention, the user uses the acquired user ID and password to effect login (Step 505). When the login is effected at the user terminal side, user authentication processing is carried out in the user authentication section 34 at the information management section side in accordance with the inputted user ID and password (Step 506). In case the login is not allowed due to incorrect ID or password or the like as a result of the user authentication (Step 507), a notification of login error is given (Step 508). In case the login is allowed as a result of the user authentication (Step 507), a contents list for the whole contents registered in the information management section is displayed on the user terminal (Step 509). Then, on the user terminal, contents to be used are selected from the contents list (Step 510). Then, converting operation information that is information related to the desired quality of contents by the user terminal, such as data capacities, data formats and numbers of colors of images, for the contents selected by the user terminal is made up (Step 511). Then, the selection of contents and user information of a user who has made up the converting operation information are retrieved in the user information management section 31, and the retrieved user information is outputted to the contents use information management section 33 (Step 512). In the contents information management section 32, a contents ID is retrieved in accordance with the contents information related to the contents selected by the user, and the retrieved contents ID is outputted to the contents use information management section 33 (Step 513). In the contents use information management section 33, contents use information related to use histories in which a user and contents are designated is retrieved, and the retrieved contents use information is outputted (Step 514). Note that, when the corresponding contents use information does not exist, the contents use information is registered by the contents use information registration processing section provided in the contents use information management section 33 into the contents use storage section. Then, the contents selected by the user are read out on the contents management section for the information management section 35 (Step 515). Then, the read-out contents are converted by the information conversion control section 10 in accordance with the read-out contents and the converting operation information (Step 516). Then, the converted contents converted by the information conversion control section 10 and the altered contents information are outputted to the user terminal (Step 517). On the user terminal, the contents information stored in the contents information management section 22 are retrieved in accordance with the altered contents information sent from the information management section (Step 518). Then, determination whether the contents are newly used or not is made in accordance with the result of the retrieval (Step 519). In case it is not the new use, contents stored in the contents storage section provided in the contents management section for the user terminal 21 are read out (Step 520). Then, conversion operation of the contents is carried out on the information conversion control section 10 on the user terminal based on the converting operation information and the contents information (Step 521). Besides, when the use of the contents is not new and after the contents are converted in Step 521, the converted contents are stored in the contents storage section provided in the contents management section for the user terminal 21 (Step 522). After passing though all of the foresaid steps, the user terminal is allowed to use the converted contents (Step 523).

Then, determination whether the contents use service according to the present invention is used again or not is made (Step 524). In case the service is used again, the operation is backed to Step 510 where the contents to be used are selected from the contents list. Whereas, the use of the service is terminated, a logoff procedure is effected to terminate the service (Step 525).

When the user desires to use the original contents, the downloaded contents are read out from the contents management section for the user terminal 21 (Step 526), and the contents are converted to the original state on the information conversion control section 10 based on the converting operation information (Step 527). At this time, determination whether the contents are converted again or not is made in accordance with information such as use frequency, elapsed period of time and time limits of contents in order to effectively use a storage medium and the like of the user terminal for storing the contents (Step 528). In case the conversion processing is carried out again, the operation is backed to Step 526. In case the conversion processing is not necessary, determination whether the reuse of the contents is required or not is made (Step 529). In case the reuse of the contents is carried out, the operation is backed to Step 505 and is commenced from the login procedure. In case the reuse is not required, the operation is terminated.

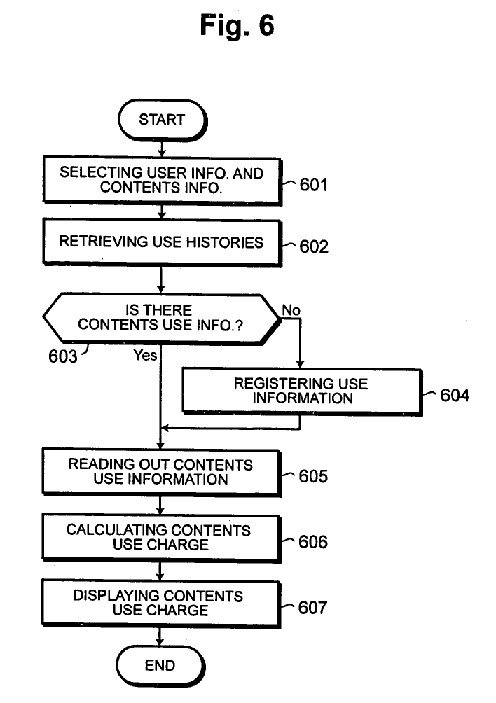

Besides, when a user is tied up with contents, an accounting processing may be carried out on the information management section. Now, the accounting processing method is described below with reference to a flow chart of FIG. 6. Firstly, user information and contents information are selected on the user information management section 31 and the contents information management section 32, respectively, based on the contents selected by the user terminal (Step 601). In accordance with the selected user information and contents information, the use histories of contents are retrieved on the contents use information management section 33 (Step 602). Then, presence of the use information of the contents is verified (Step 603). In case the use histories are absent, the use information is made up as a new use and registered (Step 604). In case the use histories are present, or after the registration processing, the corresponding contents use information is read out (Step 605). Then, in accordance with the contents use information, a given charge is calculated on the basis of presence and frequency of use of the contents (Step 606). Then, the calculated charge is displayed on the user terminal and charged to the user (Step 607). In accordance with the above-described steps, calculations of the use charges in accordance with a relation between a user and contents can be effected. When the user who had been once charged desires to use the same contents again, it is possible for the user to use the same contents again free of charge or at a lower charge than the first time. Besides, even though the mode of the electric communication network is a broad-band network type using optical fibers or the like, or a narrow-band network type such as an analog line, appropriate accounting processing can be effected under the management that ties up a user with contents, as far as the users are identical and the contents are identical.

Furthermore, it is also possible to collect the calculated charges through an electric communication network. In this case, following to a notification of the calculated use charges, the information management section performs the collection processing. On the user terminal, the payment processing for the use charges is performed in accordance with the collection processing. At this time, the payment may be done with the number of a credit card by means of an online accounting. Note that the collection processing may be performed either way of in advance or in hand.

Besides, instead of collecting the use charges for the contents, it may be configured to collect the conversion charges required for the conversion processing of the contents. In this case, the conversion charges required for the conversion processing of contents are calculated on the contents conversion calculation section, and it may be configured such that the calculated charges are collected by the conversion charge collection section. Then, the user pays the contents conversion charges. With such a configuration, not only the use charges of the contents but also the charges required for the conversion processing can be collected on the information management side. On the other hand, the user can use contents with a desired quality and the like by converting the previously-downloaded contents with only a payment for the conversion charge of the contents but with no payment for the contents themselves again.

Now, a method to remotely control, on the information management section side, the information conversion section 5 provided in the information conversion control section 10 on the user terminal side is described below. The information management section includes a contents remote control section adapted to make up control information for remotely controlling the information conversion section 5 on the user terminal side. Then, it is configured such that the information conversion control section 10 cannot be arbitrarily operated on the user terminal side when the contents are transmitted from the information management section to the user terminal. The user terminal cannot use the contents at all or can use only a little of the contents if it does not receive the control information. For instance, when a use request of contents is raised from the user terminal, basic contents and differential contents with low qualities are firstly provided to the user terminal. Until the user terminal receives the control information, only basic contents can be used on the user terminal. Then, when a use request of contents, use start date and the like are present, the control information is transmitted from the information management section to control the information control section on the user terminal side in accordance with the control information so as to make the converted contents to be the one finally desired by the user in accordance with the basic contents and differential contents. More specifically, if the contents are movie image information, it may be configured such that the movies can be used only during the initial several seconds, and if the user desires to see the whole movies, the user is requested to confirm that it desires to do so and is charged upon requirements. Upon a payment having been done, a lock system is released in accordance with the control information from the information conversion section to allow conversion of the information, thereby allowing a use of the whole movie images.

As described above, with the information conversion control method or the contents use system according to the present invention, it is needless for the contents provider to prepare contents with a plurality of qualities corresponding to the user terminals. Furthermore, the contents converters according to the present invention can keep up with a plurality of input/output data formats. Hence, the method or the system has such an excellent advantage that there is no need to redesign the contents converters into various types in order to keep up with the every format. Since it is needless to prepare contents with a plurality of qualities, effective use of network resources can be realized. In addition, since the users and the contents are tied up with each other, it is possible to avoid double accounting from occurring even though the same user used the same contents.

While the invention has been described in its preferred embodiments, it is to be understood that the words which have been used are words of description rather than limitation and that changes within the purview of the appended claims may be made without departing from the true scope of the invention as defined by the claims.

What is claimed is:

1. An information conversion control method for converting contents working as multi-media information into an information format that corresponds to a user terminal characterized in that:
converting operation information for converting and controlling contents is inputted to an information conversion management section;
a contents distinction section distinguishes that the contents are inputted, extracts contents information, that is an attribute information related to the contents contained in the contents, inputs the contents information to the information conversion management section and outputs the contents to an information conversion section;
the information conversion management section controls the information conversion section based on the converting operation information and the contents information;
the information conversion section converts the inputted contents by the control of the information conversion management section; and
the user terminal receives the converted contents.

2. The information conversion control method according to claim 1, wherein the information conversion management section comprises a registration processing section, a relevant information storage section, a retrieval processing section and a command processing section,
the registration processing section being adapted to register conversion information having information conversion section performance information and conversion processing procedure information, such as types of contents that are convertible by the information conversion section,
the relevant information storage section being adapted to store the conversion information registered by the registration processing section,
the retrieval processing section being adapted to use the converting operation information and the contents information as an input, retrieve the conversion information by means of the relevant information storage section and output the result of the retrieval,
the command processing section being adapted to receive the contents information and the conversion information from the output result of the retrieval processing section, decide the operation of the information conversion section, calculate a conversion initial parameter for actuating the information conversion section and output altered contents information, that is made up by adding the conversion initial parameter to the contents information, and
the user terminal receiving the altered contents information.

3. The information conversion control method according to claim 2, wherein the information conversion section comprises one or more contents conversion sections, a switch section and a data verification section,
the contents conversion section being outputted by receiving the calculated conversion initial parameter from the command processing section,
the switch section that selects the one or more contents conversion sections being controlled by the command processing section based on the conversion information, and
the data verification section verifying the converted contents produced by the contents conversion section.

4. The information conversion control method according to claim 3, wherein the user terminal is connected to the information conversion management section and the information conversion section via an electric communication network and receives the converted contents outputted from the information conversion section and altered contents information outputted from the information conversion management section via the electric communication network.

5. The information conversion control method according to claim 4, wherein the information conversion section is connected to the contents distinction section and the information conversion management section via the electric communication network.

6. The information conversion control method according to claim 4, wherein the user terminal selects contents to be used, makes up the converting operation information inputted to the information conversion management section and transmits the converting operation information to the information conversion management section.

7. The information conversion control method according to claim 1, wherein the information conversion section converts inputted contents in accordance with contents quality demanded by a user terminal.

8. A contents use system in which a user uses a terminal to use contents working as multi-media information from an information management section via an electric communication network according to a method according to an information conversion control method for converting contents working as multi-media information into an information format that corresponds to a user terminal wherein:
converting operation information for converting and controlling contents is inputted to an information conversion management section;
a contents distinction section distinguishes that the contents are inputted, extracts contents information, that is an attribute information related to the contents contained in the contents, inputs the contents information to the information conversion management section and outputs the contents to an information conversion section;
the information conversion management section controls the information conversion section based on the converting operation information and the contents information;
the information conversion section converts the inputted contents by the control of the information conversion management section; and
the user terminal receives the converted contents, said system being characterized in that, in the system:
the user terminal comprises:
an information input/output section adapted to input personal information related to the user and select contents presented by the information management section,
a contents registration processing section for a user terminal adapted to register contents to be used by the user,
a contents storage section for a user terminal adapted to store the contents registered by the contents registration processing section for a user terminal,
a contents read-out processing section for a user terminal adapted to read out the contents from the contents storage section for a user terminal,
a contents information registration processing section for a user terminal adapted to register the contents information including information related to contents, such as titles, IDs and information formats of contents, and to accesses to contents,
a contents information storage section for a user terminal adapted to store the contents information registered by the contents information registration processing section for a user terminal,
a contents information retrieval processing section for a user terminal adapted to use an ID included in the content information as an input, retrieve contents information corresponding to the inputted ID by means of the contents information storage section for a user terminal and output the retrieved contents information, and
a transmission/reception section for a user terminal adapted to perform transmission/reception of data with the information management section via the electric communication network, and,
the information management section comprises:
a user registration processing section adapted to register personal information of users, such as names, addresses, ages, passwords and IDs, and user information related to accesses of users,
a user information storage section adapted to store the personal information and the user information registered by the user registration processing section,
a user information retrieval processing section adapted to use the personal information as an input, retrieve user information corresponding to the inputted information by means of the user information storage section and output the retrieved user information,
a contents information registration processing section for the information management section adapted to register the contents information including information related to contents, such as titles, IDs and information formats of contents, and accesses to contents,
a contents information storage section for the information management section adapted to store the contents information registered by the contents information registration processing section for the information management section,
a contents information retrieval processing section for the information management section adapted to use an ID included in the contents information as an input, retrieve contents information corresponding to the inputted ID by means of the contents information storage section for the information management section and output the retrieved contents information,
a contents use information registration processing section adapted to register contents use information related to use histories of contents corresponding to the user,
a contents use information storage section adapted to store the contents use information registered by the contents use information registration processing section,
a contents use information retrieval processing section adapted to use the user information outputted by the user information retrieval processing section and the contents ID outputted by the contents information retrieval processing section as an input, retrieve contents use information corresponding to the inputted information by means of the contents use information storage section and output the retrieved contents use information,
a user authentication section adapted to authenticate ID, password and so on of the user to determine whether the user can use or not,
a contents registration processing section for the information management section adapted to register contents,
a contents storage section for the information management section adapted to store the contents registered by the contents registration processing section for the information management section,
a contents read-out processing section for the information management section adapted to read out the contents from the contents storage section for the information management section, and
a transmission/reception section for the information management section adapted to perform transmission/reception of data with the user terminal via the electric communication network.

9. The contents use system according to claim 8, which further comprises an accounting processing section adapted to charge charges in accordance with uses of contents by the user.

10. The contents use system according to claim 8, wherein the information management section further comprises a contents remote control section adapted to make up control information for remotely controlling the information conversion section provided for the information conversion control method for the user terminal.

11. The contents use system according to claim 8, wherein the information management section further comprises a contents charge calculation section adapted to calculate use charges required for uses of the contents and a contents use charge collection section adapted to collect use charges calculated by the contents use charge calculation section, and
the user terminal further comprises a contents use charge payment section adapted to pay use charges required for uses of the contents.

12. The contents use system according to claim 8, wherein the information management section further comprises a contents conversion charge calculation section adapted to calculate conversion charge required for conversion processing of the contents and a contents conversion charge collection section adapted to collect conversion charges calculated by the contents conversion charge calculation section, and
the user terminal further comprises a contents conversion charge payment section adapted to pay conversion charge required for conversion processing of the contents.
